(19) United States
(12) Patent Application Publication
(10) Pub. No.: US 2005/0125653 A1
(43) Pub. Date: Jun. 9, 2005

(54) Protocol for controlling access, through specific time ranges, to scrambled data

(76) Inventors: Claudia Becker, Rennes (FR); Andre Codet, Rennes (FR); Pierre Fevrier, Saint Sulpice La Foret (FR); Chantal Guionnet, Cesson Sevigne (FR)

Correspondence Address: STITES & HARBISON PLLC, 1199 NORTH FAIRFAX STREET, SUITE 900, ALEXANDRIA, VA, 22314, US

(21) Appl. No.: 10/506,501

(22) PCT Filed: Mar. 5, 2003
(86) PCT No.: PCT/FR03/00710

(30) Foreign Application Priority Data
Mar. 6, 2002 (FR) 02/02857

(51) Int. Cl. H04K 1/00; H04L 9/00

(52) U.S. Cl. 713/151; 380/28

(57) ABSTRACT

The invention relates to a protocol for controlling access to scrambled data in specific time ranges, using access control messages ECM. The protocol consists: in assigning (A) each access control message ECM a number (Tⱼ) satisfying a monotonic non-decreasing function, the messages representing a timebase formed by a plurality of individual time intervals for sending successive quanta of information; in detecting (B) in each descrambling terminal the numbers of the access control messages, and then, in response to a user request (UR) from the user; in selecting (C) an access control message number that corresponds to the sending time of the request to constitute a time origin (Tⱼₒ) of the timebase; and in authorizing (D), (E) access to the scrambled information as a function of a specific access criterion with reference to the origin (Tⱼₒ) and over a time range corresponding to a plurality of individual time intervals defining a plurality of successive quanta of scrambled information. Application to pay TV access control.

The invention relates to a protocol for controlling access to scrambled data in specific time ranges.

The transmission of scrambled information is currently experiencing unprecedented expansion because of the manifest explosion in the provision of services based on the transmission of data conveying information of the most diverse types.

As a general rule, methods of controlling access to scrambled data transmitted in point-to-multipoint mode, for example, are based on comparing access criteria supplied in access control messages or “entitlement control messages” (ECMs), against entitlements or access rights held by each user and registered in a decoder supplied to each user or preferably in an access control module, for example a smart card, supplied to each user.

To be more specific, the information is scrambled at a sending centre using a service key. The service key is contained in a control word. The control word is encrypted by means of an operating key, and the cryptogram of the control word is sent to at least one descrambling terminal associated with an access control module provided with a security processor.

The scrambled information and the periodic access control messages, ECM messages, include the cryptogram of the control word and the access criteria, with the control word and the cryptogram of the control word being changed periodically. Access to the scrambled information at each descrambling terminal is conditional upon a “true” value for the access criteria when compared with at least one access right registered in the access control module, and then upon decryption of the cryptogram of the control word using the operating key, in order to recover the control word and use it descramble the scrambled information.

For a more detailed description of such access control methods reference can usefully be made to the provisions of UTE standard C90-007, January 1994.

At present, with reference to the texts and provisions of the above-mentioned standard, since there are no provisions governing processing, from the point of view of access control proper, accessing repeat broadcasts of a television program, viewing a recorded scrambled program, and accessing the first broadcast of a program are all equivalent to accessing a first broadcast.

In particular, it is not at present possible to control specifically, through time ranges, the number of viewings, or the number of rewindings in the event of a recording.

Consequently, when access control systems are further provided with an electronic token-holder management system, for managing all aspects of access control in terms of account management, for example, any new viewing or any rewinding, in the case of a recording, results either in systematic debiting of the subscriber's electronic token-holder, in an access mode known as time-based impulsive purchase, or in unlimited access, if access is authorized in all other marketed access modes.

An object of the present invention is to remedy the drawbacks and limitations of prior art access control methods.

In particular, a more specific object of the present invention is to provide a protocol for controlling access to scrambled information in specific time ranges of adjustable particular durations.

Another object of the present invention is to provide a protocol for controlling access to scrambled information in specific time ranges, with it being possible for the origin of a specific time range to be defined with reference to a specific action of each user.

Given the adjustable nature of the duration of the access time range and/or of the origin of said access time range with reference to a specific action of each user, another object of the present invention is to implement a plurality of new services associated with the broadcasting of television programs, such as: a service for previewing a broadcast television program for a particular time; a controlled rewind access service after recording a broadcast television program; a service for counting the number of viewings in the event of looped broadcasting of television programs.

A further object of the present invention is to implement an access control protocol which, through identification of all or part of a program already viewed by a subscriber (to which access has therefore already been granted), distinguishes any period that has already been viewed by the user, and thus optimizes the management of viewings based on a criterion of some particular number of repeat viewings, or a new viewing as the case may be.

In the context of recording television programs, a further object of the present invention is to implement an access control protocol for limiting the number of playbacks, and for limiting the magnitude of the authorized rewind.

The protocol of the invention for controlling access to scrambled information is implemented at a broadcast centre. Scrambling is effected using a service key contained in a control word. The control word is encrypted by means of an operating key, and the access control protocol consists at least in sending the scrambled information and periodic access control messages, ECM messages, to at least one descrambling terminal associated with an access control module provided with a security processor, the ECM messages, containing access criteria and the cryptogram of the control word. The control word and the cryptogram of the control word are changed periodically. Access to the scrambled information at each descrambling terminal is conditional upon a “true” value for the access criteria when compared with at least one access right registered in the access control module and then upon decrypting the cryptogram of the control word using the operating key, in order to recover the control word and descramble the scrambled information.

The protocol is remarkable in that it further consists in assigning each access control message, ECM message, a number satisfying a monotonic non-decreasing function, consecutive messages ECMⱼ with successive numbers Tⱼ representing a timebase formed by a plurality of individual time intervals for sending successive individual quanta of scrambled information. The protocol then consists, in each descrambling terminal, in detecting the number of each access control message, message ECMⱼ, and then, at the request of the user of said descrambling terminal for conditional controlled access to at least a portion of said scrambled information, in selecting an access control number that corresponds to the sending time of said request, and in constituting a time origin of said timebase.

Access by the user to the scrambled information is authorized as a function of a specific access criterion from said origin of the timebase over a time range corresponding to a plurality of individual time intervals defining a plurality of successive individual quanta of scrambled information.

The access control protocol of the present invention is particularly suitable for point-to-multipoint transmission of scrambled information, in particular television programs, and managing pay TV services in general.

The protocol will be better understood on reading the following description and examining the appended drawings, in which:

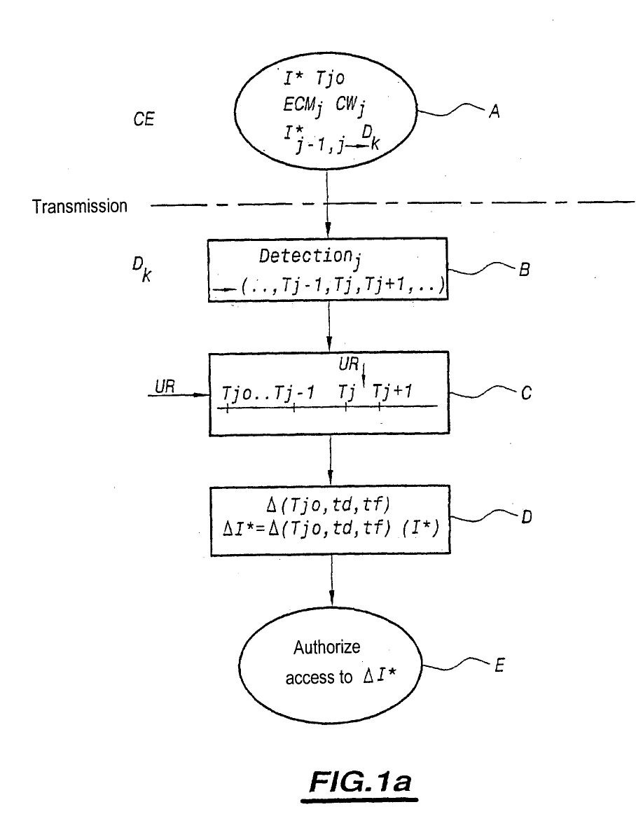

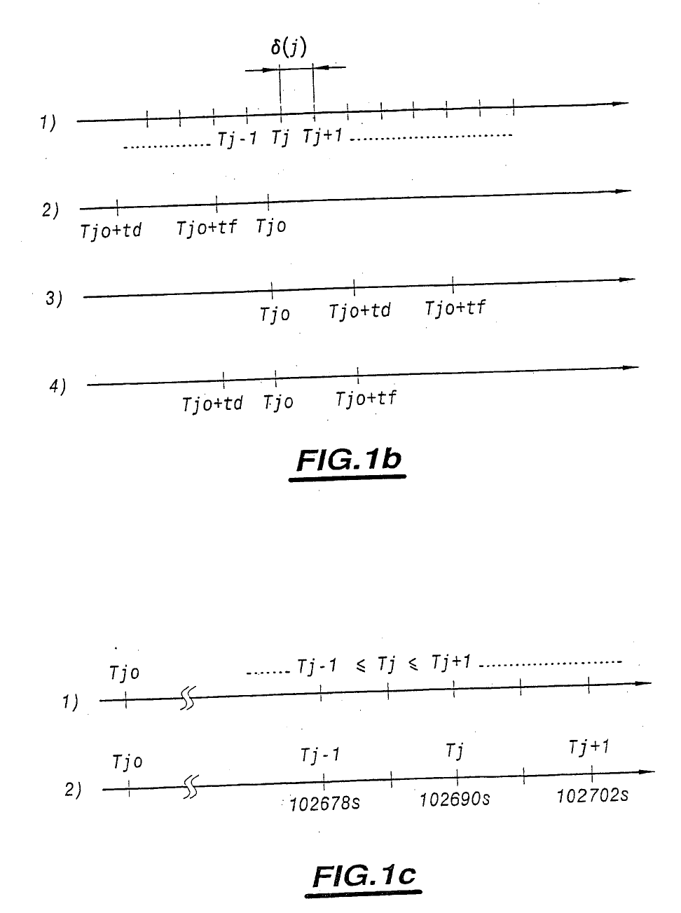

FIG. 1a is, by way of purely illustrative example, a general flowchart for implementing the protocol of the present invention;

FIG. 1b comprises different timing diagrams illustrative of time ranges constituting a backward interval, a forward interval, and a forward-backward interval, respectively;

FIG. 1c represents, by way of purely illustrative example, different embodiments of a monotonic non-decreasing function;

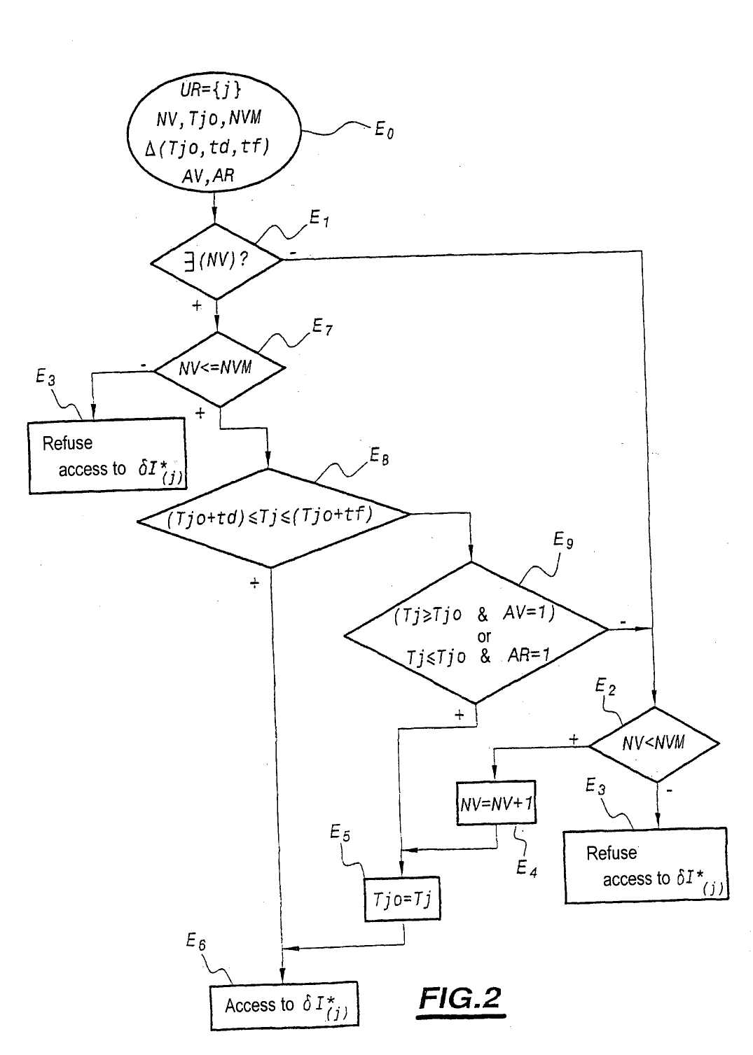

FIG. 2 is, by way of purely illustrative example, a flowchart of a specific implementation of the protocol of the present invention, more particularly suited for managing services such as a previewing service for a scrambled broadcast TV program, a rewind service, and a service for managing numbers of viewings in the event of looped broadcasting.

A more detailed description of the protocol of the present invention for controlling access to scrambled information is given below with reference to FIG. 1a and the subsequent figures.

Generally speaking, the protocol that is the subject matter of the present invention is implemented firstly at a transmission centre CE and secondly at a plurality of descrambling terminals Dₖ, each associated with an access control module constituted by a dedicated smart card including a security processor, for example.

The information I is scrambled at the transmission centre CE using a service key contained in a control word CW that is encrypted by means of operating key in a manner that is known in the art.

The scrambled information I* is transmitted with periodic access control messages, known as ECM messages. The messages contain access criteria. The cryptogram of the control word CW, and in particular the control word, are changed periodically. Access to the scrambled information at each descrambling terminal Dₖ is conditional upon the access criteria conveyed by the access control messages ECM giving a “true” value when compared with at lest one access right registered in the access control module associated with each descrambling terminal Dₖ.

The cryptogram of the control word is decrypted at each descrambling terminal, and in particular in the access control module, using the operating key, in order to recover the control word CW and descramble the scrambled information I*.

According to a remarkable aspect of the protocol of the present invention for controlling access to scrambled information, the protocol further consists in, the transmission centre CE in particular, assigning each access control message, ECM message, a number Tⱼ satisfying a monotonic non-decreasing function, for which reason the access control messages are denoted ECMⱼ, where j designates the rank of the above-mentioned number.

According to a particularly remarkable aspect of the protocol of the present invention, the consecutive control messages ECMⱼ with successive numbers Tⱼ represent a timebase formed by a plurality of individual time intervals for transmitting successive individual quanta of scrambled information. It will thus be understood that between two successive numbers, for example the numbers Tⱼ₋₁, Tⱼ, corresponding to at least one time interval δ representative of the sending times of the control messages ECMⱼ, an individual quantum of scrambled information denoted δI*₍ⱼ₋₁₎ is sent to each descrambling terminal Dₖ.

At each of the above-mentioned descrambling terminals D_{k,} the protocol of the present invention then consists in a step B of detecting the number Tⱼ of each access control message ECMⱼ. The operation of detecting the number of each access control message is accompanied by storing the current number.

According to another particularly remarkable aspect of the protocol of the present invention, the invention consists, at the request of the user of the descrambling terminal Dₖ concerned for conditional access to at least a portion of the scrambled information, in selecting, in a step C, a number for an access control message ECMⱼ, which number corresponds to the sending time of the user request UR.

Clearly, since the user sends a user request UR over the descrambling terminal (the request may be sent from a program selector such as a remote controller, for example, or by any other means), the sending time of the request is identified relative to the current number Tⱼ detected in the preceding step B, and in particular relative to an earlier event, such as a previous access, as is explained below. The earlier event may correspond to a previous access defining the origin of the timebase whose number is Tⱼₒ.

In particular, the number Tⱼₒ constituting the origin time of the timebase, and which is obtained in the step A, may advantageously correspond to the number of the message ECMⱼₒ of the most recent previous non-free controlled access stored in the access control module or the card issued to the user, as is explained below.

In FIG. 1a, there is symbolically represented in the step C the series of successive numbers Tⱼ₋₁, Tⱼ, Tⱼ₊₁ and a user request UR, the number Tⱼₒ for the origin of the timebase being deemed to be less than (i.e. earlier than) the successive numbers of the sequence Tⱼ₋₁, Tⱼ, Tⱼ₊₁. In any event, it is clear that the number Tⱼₒ for a previous access may nevertheless be greater than the current number Tⱼ identifying the sending of the user request UR by the user.

This is the case when accessing programs broadcast in a loop with the same access control parameters ECMⱼ or when accessing recorded programs, for example.

Step C of selecting the access control message number may then be followed by a step D of authorizing access by the user to the scrambled information as a function of a specific access criterion, starting from the origin Tⱼₒ of the timebase and over a time range corresponding to a plurality of individual time intervals defining a plurality of successive individual quanta of scrambled information.

For this reason, in FIG. 1a, Δ (Tⱼₒ, td, tf) represents the access time range assigned to the user, where:
jo represents the rank of the number Tⱼₒ defining the origin of the timebase;
td represents an offset of the numbers in the timebase relative to the above-mentioned origin Tⱼₒ; and
tf represents another offset of the numbers relative to the above-mentioned origin Tⱼₒ.

By way of a non-limiting example, the above-mentioned offsets can correspond to at least one individual time interval δ taken to be equal to the sending time of the access control message ECMⱼ.

In this case, each successive individual time interval at the time j of receiving the message ECMⱼ is denoted δ(j) and the corresponding individual quantum of information is denoted:
δI*₍ⱼ₎=δ₍ⱼ₎(I*)

It can thus be understood that, by means of the user request UR as formulated, the user is authorized to access the information ΔI*=Δ(Tⱼₒ, td, tf) (I*) over a plurality of individual time intervals δ₍ⱼ₎ in the final step E in FIG. 1 for successive quanta of information δI*₍ⱼ₎ over the time range ΔI*=Δ(Tⱼₒ, td, tf)

The purpose of FIG. 1b is to illustrate parameters for defining the current access number corresponding to the user request, and previous user access numbers stored in the card in order to constitute the origin Tⱼₒ of the corresponding timebase, and for a start time td, and an end time tf relative to the origin Tⱼₒ of the timebase; the parameters Tⱼₒ, td, and tf therefore define the time range for access authorized in accordance with the specific access criteria, as mentioned above.

Line 1 in FIG. 1b represents the succession of numbers for received messages ECMⱼ, where j designates the rank of the current number for the corresponding message ECMⱼ.

In relation to lines 2, 3 and 4 in FIG. 1b:
the origin Tⱼₒ of the timebase is the most recent access stored in the user's card, for example the most recent non-free of charge access, to the program of scrambled information I* concerned;
td is the offset relative to the origin Tⱼₒ corresponding to the start of the time region, or time range, to which access is authorized on the basis of a specific access criterion; and
tf is the offset relative to the origin Tⱼₒ corresponding to the end of the time region, or time range, to which access is authorized in accordance with the specific access criterion.

With reference to lines 2, 3 and 4 in FIG. 1b:
the time range, or interval, is backward for td≦0 and tf≦0;
the interval, or time range, is forward for td≧0 and tf≧0;
the time range, or interval, is a “straddling” time range, i.e. forward and backward, for td≦0 and tf≧0.

Specifically, although this is not limiting on the invention, the current number of a message ECMⱼ is always non-decreasing during the transmission of a broadcast program. However, if the program is broadcast in a loop, or if it corresponds to a program recorded on a recorder and played back, the value Tⱼₒ stored in the card assigned to the subscriber may correspond to a previous access and be relative to the time interval, or time range, defined by Tⱼₒ, td, and tf, as represented in lines 2, 3, and 4 in FIG. 1b. Use of the protocol of the present invention is beneficial in these three situations.

Different implementations of a number Tⱼ satisfying a monotonic non-decreasing function are described below with reference to FIG. 1c.

Line 1 of FIG. 1c represents a monotonic non-decreasing function in the form of a continuously increasing function of the sending time for control messages ECMⱼ. For example, each number Tⱼ is constant over the individual time period δ₍ⱼ₎ and satisfies the condition:
Tⱼ₋₁≦Tⱼ≦Tⱼ₊₁

Line 2 in FIG. 1c represents a monotonic non-decreasing function in the form of a stepped increasing function of the sending time for control messages ECMⱼ.

With particular reference to line 2 in this figure, it is clear that each control message ECMⱼ may be repeated over one or more individual time intervals between the successive numbers Tⱼ₋₁, Tⱼ et seq. This mode of operation defines a timebase with a resolution other than the sending time for control messages ECMⱼ.

As also represented in the same line 2, each number Tⱼ may be defined by a timestamp. In the example given in FIG. 2, the timestamp is a time value expressed in seconds. Each step Tⱼ₋₁, Tⱼ et seq. is then defined by the time range represented by the two different timestamps, for example.

An object of the protocol of the present invention is to manage the number of viewings NV of the same program broadcast and/or recorded by a user, where each viewing may comprise access to the same program one or more times, access at two or more separate times being included the same viewing and, in this situation, since the number of viewings is unchanged, no additional amount is billed to the user in this kind of situation.

The change, however, from one access to another by the user in the same program under conditions other than the specific access above-mentioned criterion counts as two different viewings, one “viewing” and one “other viewing”, the other viewing leading to incrementing the number of viewings and to an additional amount being billed to the user, as described below.

Referring to FIG. 2, managing the number of viewings NV of programs at the request of the user and according to the specific access criterion in the above-defined time range and outside that time range, the access criterion may, as represented in FIG. 2, consist in a step E₀ of defining a maximum authorized number of viewings NVM of the scrambled broadcast program containing the scrambled information I*. The protocol of the invention may further define a first Boolean variable AV whose “true” value represents authorization for forward access to the scrambled information I* beyond the origin and outside the above-defined time range without incrementing the number of viewings, with such access to the information beyond the origin and outside the time range being authorized on the basis of an access criterion separate from the specific access criterion defining access in the above-mentioned time range.

The protocol may also define a second Boolean variable AR whose “true” value is representative of authorization for backward access to the scrambled information before the origin and outside the time range on the basis of an access criterion different from the above-mentioned specific access criterion and without incrementing the number of viewings.

In a preferred embodiment of the protocol of the present invention, the access criterion specific to the above-defined access time range or region, in particular as defined by the offset parameters td and tf relative the origin Tⱼₒ of the timebase, may advantageously allow the user free access, i.e. unbilled access, in that range.

By way of purely illustrative example, it is specified that the Boolean variables AV and AR referred to above have the value 1 for the “true” value and the value 0 for the “false” value.

In the step E₀ in FIG. 2, on the user sending the user request UR defined by the rank j of the number Tⱼ of the corresponding access control message ECMⱼ, there are available:
variables NV, Tⱼₒ if a previous access has been made to the same scrambled data program, Tⱼₒ representing the stored value serving as the origin for the next access resulting from the request UR, and NV designating the number of viewings already effected;
the authorized maximum number of viewings NVM;
the Boolean variables AV and AR; and
the time range Δ(Tⱼₒ, td, tf)

Finally, to implement the protocol of the present invention, it may be advantageous to initialize the number of viewings NV to zero if the user has made no accesses and thus has not viewed any corresponding scrambled data program.

In this case, and as represented in FIG. 2, the protocol of the invention may test for the existence of the variable NV in the step E₁. This test is denoted:
∃(NV)?

In the event of a negative result of the test E₁, i.e. if there is a variable NV equal to 0 for the scrambled information I* concerned, then a step E₂ is executed which tests whether the number of viewings NV is less than the maximum number of viewings NVM.

It is clear, of course, that in this starting situation the result of the test E₂ is generally always positive, since the number of viewings NV is equal to 0 in this situation.

In the event of a positive result of the test E₂, a step E₄ is executed which increments the value of the number of viewings by 1, in accordance with the following equation:
NV=NV+1

Clearly, in this case, the access to the scrambled information program I* is the first access.

In this case, the step E₄ may then be followed by a step E₅ which, for the first viewing, updates the origin of the timebase, i.e. the value Tⱼₒ to the value Tⱼ which is none other than the reception number for the user request UR, i.e. the reception number for the corresponding message ECMⱼ.

The step E₅ of updating the origin of the timebase may then be followed by access to the individual quantum of information δI*₍ⱼ₎ in a step E₆. Clearly, in this case, the first access corresponds to a first viewing and the access criterion applied is an access criterion different from the specific access criterion corresponding to free access.

But, in the event of a positive result of the above-mentioned test E₁, because the value of NV is not equal to 0, there are at least one earlier access and at least one earlier viewing.

In this case, the step E₁ is followed by a step E₇ of testing whether the number of viewings NV is less than or equal to the authorized maximum number of viewings NVM.

In the event of a negative result from the test E₇, access to the scrambled information is refused in the step E₈ because the user has clearly exceeded the viewing quota NVM.

However, if the result of the test E₇ is positive, the protocol of the invention then tests, in step E₈, whether the current number Tⱼ lies within the time range.

The step E₈ test of whether the current number Tⱼ is in the time range, satisfies the condition:
(Tⱼₒ+td)≦Tⱼ≦(Tⱼₒ+tf)

In the event of a positive result from test E₈, access to the individual quantum of scrambled information δI*₍ⱼ₎ is authorized, in the above-described step E₆, on the basis of the specific access criterion and during the scrambled information time range.

It is clear, of course, that access during the time range consists in particular in authorizing successive access to each quantum of information covering the time range, as mentioned above.

It is equally clear that, if the specific access criterion corresponds to a free access criterion, i.e. when there is nothing to be billed to the user, access is effected directly, in step E₆, without incrementing the number of viewings NV.

However, if the result of the test E₈ is negative, access to the scrambled information is authorized on the basis of an access criterion different from the specific access criterion, and is conditional upon the above-mentioned Boolean variables having the “true” value.

Clearly, given the values of the above-mentioned Boolean variables, it is possible to determine whether any new access, upstream or downstream of the above-mentioned origin, contributes or does not contribute to a new viewing.

Accordingly, if the current number Tⱼ does not belong to the above-mentioned time range, i.e. in the event of a negative result from test E₈, authorization of access on the basis of an access criterion different from the specific access criterion and conditional on a “true” value of a Boolean variables may consist, in a step E₉ and as represented in FIG. 2, in submitting the current number Tⱼ representative of the sending time of the user request UR and the first Boolean variable AV to a first logic test to verify whether the current number Tⱼ is greater than or equal to the number Tⱼₒ for the origin and to verify that the first Boolean variable AV has the “true” value for authorizing forward access to the scrambled information.

The test E₉ also submits the current number Tⱼ and the second Boolean variable AR to a second logic test to verify whether the above-mentioned current number Tⱼ is less than or equal to the number Tⱼₒ for the origin and to verify whether the second Boolean variable AR has the “true” value for authorizing backward access to the scrambled information.

In the test E₉ in FIG. 2, the first and second logic tests satisfy the condition:
(Tⱼ≧Tⱼₒ AND AV=1) OR (Tⱼ≦Tⱼₒ AND AR=1)

In the event of a positive result from test E₉, i.e. in the event of a positive result of either of the above-mentioned first and second logic tests, then forward access, or backward access as the case may be, is authorized without incrementing the number of viewings of the scrambled information.

Clearly, for any user request UR corresponding to a reception number Tⱼ outside the time range defined in the step E₈ and greater than the number Tⱼₒ at the origin, the “true” value of the Boolean variable AV, indicating a forward request, i.e. continued viewing, indicates that the user wishes to resume the earlier viewing. This may be effected by the user to the detriment of the non-viewing of all the quanta of scrambled information from Tⱼₒ to Tⱼ.

The same applies to the second logical test, where the current number Tⱼ is this time lower than the origin number Tⱼₒ. This may be the case, for example, either on returning to a program broadcast in a loop or on rewinding a recording on a recorder. In the same way, in this kind of situation, the user wishes to view an earlier episode which may or may not have been accessed previously.

Authorization of forward access (or backward access as the case may be) without incrementing the number of viewings, following a positive result from test E₉, entails executing the step of updating the origin number Tⱼₒ, which is updated to the value Tⱼ, in step E₅. Step E₅ is then followed by step E₆ which accesses the individual quantum of scrambled information δI*₍ⱼ₎.

Otherwise if the result from test E₉ is negative, since neither the first nor the second logical test is satisfied, the protocol of the invention tests in step E₂ whether the number of viewings NV is less than the authorized maximum number of viewings NVM.

In the event of a negative result of above-mentioned test E₂, access to the individual quantum of scrambled information δI*₍ⱼ₎ is refused in step E₃, the user having exhausted the quota of viewings for the program concerned. Otherwise, in the event of a positive result from test E₂, the number of viewings NV is incremented by 1, in above-mentioned step E₄, said step E₄ being followed by authorization of forward access (or backward access as the case may be), to the scrambled information via above-mentioned updating step E₅.

It is therefore clear that, because of the incrementation in the step E₄, i.e. the user has chosen an access constituting a new viewing, the new viewing will be billed as such, the new access constituting a new viewing.

An embodiment of the protocol of the present invention for a service corresponding to a single rewinding of a recording on a device such as a recorder is described below with reference to FIG. 2.

By way of non-limiting example, in this situation, the maximum number of viewings NVM may be taken as equal to 1, for example, and the time interval or the time range for which access is authorized in accordance with the specific access criterion, and in particular in accordance with free access, is defined by the following parameters:
td<0
tf=0.

In this kind of application to the above-mentioned service, the Boolean variables are respectively forced as follows:
AV=1
AR=0.

Clearly, in this case, the user is assigned a maximum viewing time by rewinding, as defined above. Outside this interval, only forward viewing from the position Tⱼₒ is authorized, because of the “true” or “false” values of the above-mentioned Boolean variables.

A second embodiment of the protocol of the present invention is described below with reference to the same FIG. 2 in an application to a preview service.

The preview service in fact corresponds to free forward access authorizations relative to the origin of the timebase.

In a situation of this kind, the maximum number of viewings may be taken as equal to 1, for example: NVM=1. This example is not limiting on the invention.

The access time area according to the specific access criterion, such as the above-mentioned free access criterion, is then defined by:
td=0
tf>0.

In this case, for the preview service, the Boolean variables for the recorder forward and reverse control functions may be taken as equal to AV=0 and AR=0, respectively. In this case, in the context of the preview service, the user is authorized to view only in the above-mentioned time interval or time range a number of successive quanta of scrambled information determined by the magnitude |tf−td| determined in a specific manner. It is recalled that the magnitude of the above-mentioned time range may correspond to three minutes of viewing, for example.

A third embodiment of the protocol of the present invention is described below with reference to the same FIG. 2, in an application to controlling the number of viewings during the broadcasting of a program in a loop, for example.

In this application, the maximum number of viewings NVM for the scrambled information program concerned may be defined arbitrarily.

By way of non-limiting example, the magnitude of the time region for which access is authorized in accordance with the specific access criterion, i.e. free access, may be arbitrarily set at 0: td=0 AND tf=0.

In this case, it is clear that the user is authorized to consult any scrambled information program broadcast in looped mode in accordance with an access criterion different from the specific access criterion and corresponding to at least one of the access rights registered in the user's card being satisfied.

In this situation, only basic forward access is authorized, i.e. access to successive quanta of scrambled information, the Boolean variables taking the values:
AV=1
AR=0.

1. A protocol for controlling access to information scrambled at a broadcast centre using a service key contained in a control word, the control word being encrypted by means of an operating key, the access control protocol consisting at least in sending said scrambled information and periodic access control messages, ECM messages, to at least one descrambling terminal associated with an access control module provided with a security processor, the ECM messages containing access criteria and the cryptogram of the control word, the control word and the cryptogram of the control word being changed periodically, access to said scrambled information at each descrambling terminal being conditional upon a “true” value for said access criteria when compared with at least one access right registered in the access control module, and then upon decrypting said cryptogram of the control word using the operating key, in order to recover said control word and to descramble said scrambled information, the protocol being characterized in that it further consists:
in assigning each access control message, ECM message, a number (Tⱼ) satisfying a monotonic nondecreasing function, consecutive messages ECM, with successive numbers representing a timebase formed by a plurality of individual time intervals for sending successive individual quanta of scrambled information;
in detecting in each descrambling terminal the number (Tⱼ) of each access control message, message ECMⱼ, and then, in response to a user request (UR) from the user of said descrambling terminal for conditional controlled access to at least a portion of said scrambled information;
in selecting a number for an access control message, message ECMⱼ the number corresponding to the sending time of said request, and constituting a time origin (Tⱼₒ) of said timebase; and
as a function of a specific access criterion, in authorizing said user to access said scrambled information from said origin (Tⱼₒ) of said timebase over a time range corresponding to a plurality of individual time intervals defining a plurality of successive individual quanta of scrambled information.

2. A protocol according to claim 1, characterized in that said time range is defined by a first offset (td) from said origin (Tⱼₒ) corresponding to the beginning of the access as a function of said specific access criterion, and a second offset (tf) corresponding to the end of the access as a function of said specific access criterion.

3. A protocol according to claim 1, characterized in that said monotonic non-decreasing function is a continuously increasing function of the sending time of the control messages ECMⱼ.

4. A protocol according to claim 1, characterized in that said monotonic non-decreasing function is an increasing step function of the sending time of the control messages ECMⱼ.

5. A protocol according to claim 4, characterized in that each step is defined by a constant number over a plurality of sending times of the control messages ECMⱼ which defines a timebase with a resolution different from the sending time of the control messages ECMⱼ.

6. A protocol according to claim 5, characterized in that each number is defined by a timestamp, each step being defined by the time range represented by two separate timestamps.

7. A protocol according to claim 2, characterized in that said specific access criterion corresponds to free access.

8. A protocol according to claim 2, characterized in that said time range is either an interval backwards from said origin, td≦0 AND tf≦0, or an interval forwards from said origin, td≧0 AND tf≧0, or a forward and backward interval, td≦0 AND tf≧0.

9. A protocol according to claim 1, characterized viewings (NV) at the request the user in accordance with said specific access criterion in said time range and outside said time range, the protocol consists at least:
in defining a maximum authorized number of viewings (NVM);
in testing whether the number of viewings (NV) is less than or equal to said authorized maximum number of viewings (NVM); and,
in the event of a negative result of said test, refusing access to the scrambled information; else
in testing whether said current number (Tⱼ) is in said time range; and,
in the event of said current number (Tⱼ) being in said time range; in authorizing access to said scrambled information on the basis of the specific access criterion during said time range; else
in authorizing access on the basis of a distinct access criterion other than specific access criterion and on condition that a Boolean variable representative of forward access authorization or of backward access authorization, respectively, presents a “true” value.

10. A protocol according to claim 9, characterized that it further consists:
in defining a first Boolean variable (AV) whose “true” value is representative of authorization of forward access to said scrambled information beyond said time range, on the basis of an access criterion other than said specific access criterion; and
in defining a second Boolean variable (AR) whose “true” value is representative of authorization of backward access to said scrambled information before said time range, on the basis of an access criterion other than said specific access criterion.

11. A protocol according to claim 9, characterized in that, if said current number (Tⱼ) is not in said time range, said authorization of access based on an access criterion other than said specific access criterion and conditional upon the “true” value of said Boolean variables consists:
in submitting said current number (Tⱼ) and said first Boolean variable (AV) to a first logical test to verify whether said current number (Tⱼ) is equal to or greater than said origin number (Tⱼₒ) and to verify whether said first Boolean value is “true” in order to authorize forward access to said scrambled information or to a second logical test to verify whether said current number (Tⱼ) is equal to or the less than said origin number (Tⱼₒ) and to verify whether the value of said second Boolean variable is “true” in order to authorize backward access to said scrambled information and, in the event of a positive result of either of the first or second logical tests:
in authorizing forward access, or backward access as the case may be to said scrambled information with no incrementing of the number of viewings and, in the event of a negative result of both the first and second logical tests:
in testing whether said number of viewings (NV) is less than the authorized maximum number of viewings (NVM); and
in the event of a negative result of said test, in refusing access to the scrambled information and incrementing said number of viewings (NV) by 1, else
in authorizing forward, respectively backward, access to said scrambled information.

12. A protocol according to claim 11, characterized in that, for a specific access control corresponding to a basic rewind service for a recording and an authorized maximum number of viewings NVM=1, said time range is a backward range defined by td<0 AND tf=0, the first Boolean variable is “true”, forward access being authorized, and the backward second Boolean variable is the complement of the “true” value, backward access not being authorized.

13. A protocol according to claim 11, characterized in that, for a specific access control corresponding to a free access preview service, said time range is a forward range defined by td=0 AND tf>0, the authorized maximum number of viewings is NVM=1, the first and the second Boolean variables are “false”, recording and/or backward access not being authorized.

14. A protocol according to claim 11, characterized in that, for looped transmission of scrambled information, said authorized maximum number of viewings is set a particular value, said time range for access to the scrambled information has a specific value, the first Boolean variable is “true” and the second Boolean value is “false”.
